(19) United States
(12) Patent Application Publication
(10) Pub. No.: US 2002/0059694 A1
(43) Pub. Date: May 23, 2002

(54) Handi-helper

(76) Inventor: Bernard Martin Knowlton, Santa Barbara, CA (US)

Correspondence Address: BERNARD M. KNOWLTON, PO BOX 6464, SANTA BARBARA, CA, 93160, US

(21) Appl. No.: 09/977,524

(22) Filed: Oct. 13, 2001

Related U.S. Application Data
(60) Provisional application No. 60/238,617, filed on Oct. 10, 2000.

(51) Int. Cl. E05B 1/00; A45C 3/00

(52) U.S. Cl. 16/429

(57) ABSTRACT

This invention provides the handicapped person, [or other persons with a similar problem of partial immobility in their legs, or back which inhibits their full movement], a new lease on on life and more independence which is so valuable to such persons. It opens up a new life as I experienced in my situation. This invention will be welcomed by users in need of assistance which they can now perform themselves without trial and tribulation since the invention is so easy to use and retrieves so many objects. The invention is easy to carry in the wheelchair's pocket, in a lady's handbag, in a man's pocket. It is very light in weight, sturdy in construction, smart looking, and will perform to most people's satisfaction.

### BACKGROUND OF THE INVENTION

This invention is the result of the inventor being a victim of a hit- and-run accident and suffering injured hips, legs, and back. This required extensive time spent in an ordinary office chair during my recovery. From experience in dropping items to the floor such as paper, paper clips, computer discs and other related items from a desk, it become apparent very quickly that since it was impossible to retrieve the items without incurring severe pain by stretching or bending over to reach the items, some type of handle would be necessary to relieve this situation. Upon searching for such a handle, it was discovered that none was available during my search. As a result, I invented the Handi-Helper to solve the problem for the handicapped as well as for the handicapped's caretaker who in many cases must be called to retrieve the objects.

The invention consists of a telescopic extender fitted with a soft foam rubber handle, something like a bicycle handle, and supplied with four accessories that will retrieve most items dropped frequently not only from a working desk situation but in any case in the everyday environment. These accessories—ACC.—are applied to the base unit at the bottom tip of the extemder by the use of Velco pads. The base unit has the coarse section of the Velco applied to it, all accessories have the fine section of the Velco applied to them. The accessories are attached to the base unit as required by the type of retrieval that is being accomplished. Once the type of accessory has been determined, it is selected from the accessory container and quickly and easily attached to the base unit. When the retrieval has been completed, that accessory is detached from the base unit by pulling on the accessory which breaks the bond between the two Velco fasteners; coarse fastener on base unit, fine fastener on the accessory unit. The ACC unit is then returned to its carrying container which is a small container that is very similar to that of the container used for the sale of men's cuff links, container not a part of this invention. This invention is primarily designed for those handicapped who must spend a large portion of their time in a wheelchair, although it can be very handy for those individuals who are unable to bend over without severe pain or discomfort. The invention is small enougth to be carried in a woman's handbag or in a man's pocket.

NOTE: More detailed instructions and information are included on the drawing 2/2.

The inventor has no knowledge of a similar device that assists handicapped persons and those persons who may not be classified as handicapped but require this assistance.

### SUMMARY OF THE INVENTION

This invention is sorely needed by handicapped persons. It will be easy to make and to use. All of the materials are readily available at reasonable cost. It will provide that very important feeling of more independence to all of the people who use it.

### BRIEF DESCRIPTION OF THE DRAWINGS

FIG. 1 is a front view of the invention illustrating the retracted position of the extender rod.

FIG. 2 is a front view of the invention illustrating the handle portion in a cutaway position.

FIG. 3 is a top view of the invention showing the full top on the left side and the cutaway top view on the right side.

FIG. 4 is a bottom view of the invention.

FIG. 5 is a front view with extender rod in its full extension position.

FIG. 6 is a bottom view illustrating ACC. 4 attached to the fixed bottom of the extender rod.

### DETAILED DESCRIPTION OF THE EMBODIMENTS

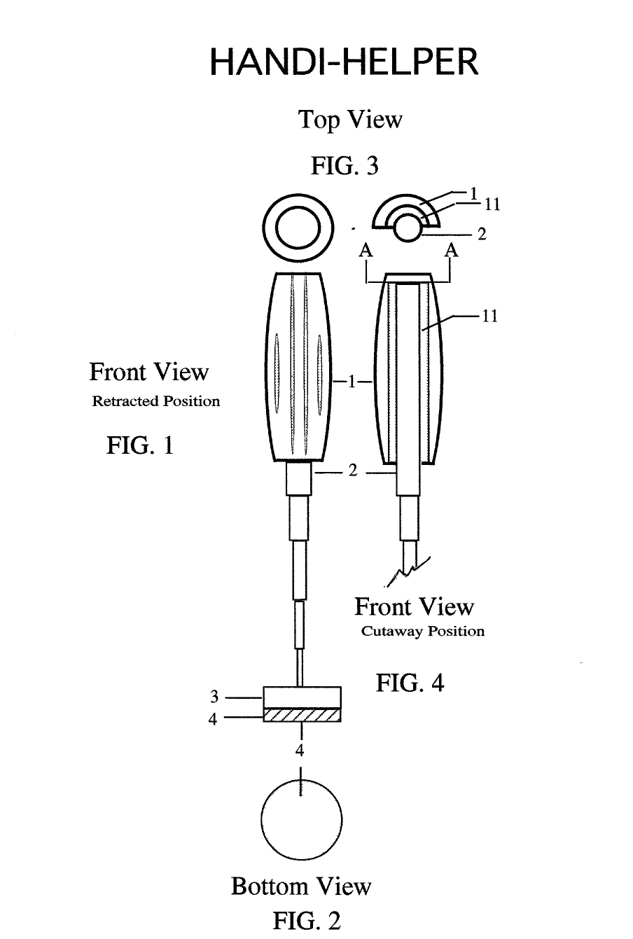

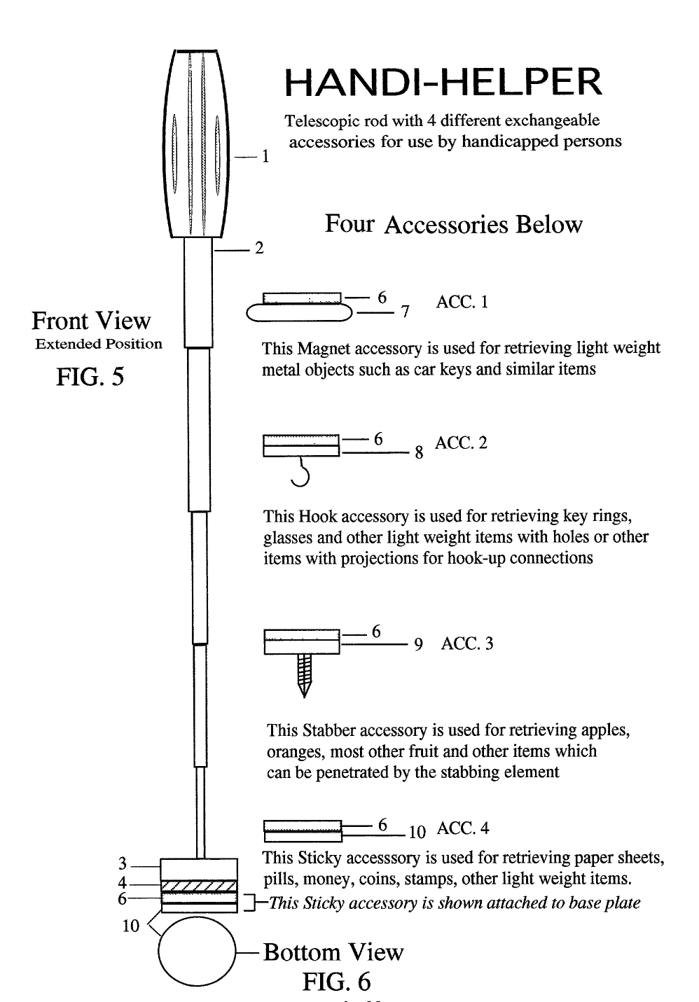

FIG. 1 shows the front view with the soft foam handle 1 at extreme top. The extender rod 2 in its retracted position.

FIG. 2 shows the bottom view with coarse Velco 4 attached bottom base 3.

FIG. 3 shows the top full view on the left side with cutaway section AA displaying the foam rubber handle 1 with inside hard plastic core 11 with extender rod 2 in its full diameter size. The extender is retained in the hard plastic core 11, the foam rubber handle 1 fits tightly over the core 11.

FIG. 4. shows front view with the extender rod in a cut-off mode.

### DETAILED DESCRIPTION OF THE INVENTION

This invention is the true meaning of the old saying “necessity is the mother of invention”. After being the victim of a hit-and-run car accident in which my hips and back were severely injured at my age of 82 years, I was devastated to finally learn that I would spend time in a disabled medical condition. It was during my time in my office chair at my computer that I abruptly realized I needed some type of tool to pick up items from the floor such as paper, computer discs, paper clips, etc, that I seemed to be dropping constantly, partially due to my restricted movements. In my endeavor to purchase a pickup tool, to my dismay I discovered there was nothing available that fulfilled the need as I perceived it. So I preceeded to make one from my own ideas of the best features. It incorporates a feature that permits it to be easily carried regardless of where the owner might go. It wisely is designed to permit the length of it to be adjustable from short enough to be carried in a lady's handbag or a man's pocket to long enough to reach the floor even while in a standing position. Further it is provided with four accessories that can be exchanged easily and quickly which makes it very versatile to handle almost any article that would be dropped. In short, it is a telescopic rod with the butt end encased in a soft foam rubber handle and a tip that can be extended out to user's choice of the working position. Four accessories that can be attached to and removed from the tip as required for the pick-up procedure.

1. What I claim as my invention is a handle that makes it convenient and comfortable for handicapped individuals to gain some independence by using the Handi-Helper invention. The invention is a telescopic extender (rod) that retracts into a soft foam rubber handle when it is not in use. For use, the extender can be pulled out to the length desired and with the correct accessory mounted on the tip, it is easy to retrieve objects. It permits them to retrieve objects from the floor without asking for assistance from their spouse or their caretaker. It has four different accessories that permit a quick change from one type to another type depending upon the object to be retrieved. The different accessories can be placed upon the tip of the invention and replaced quickly and easily.
